(19) United States
(12) Patent Application Publication
(10) Pub. No.: US 2014/0168126 A1
(43) Pub. Date: Jun. 19, 2014

(54) DYNAMIC BORDER CONTROL SYSTEMS AND METHODS

(71) Applicant: Jeffrey N. Yu, Honolulu, HI (US)

(72) Inventor: Jeffrey N. Yu, Honolulu, HI (US)

(21) Appl. No.: 14/107,899

(22) Filed: Dec. 16, 2013

Related U.S. Application Data
(60) Provisional application No. 61/737,278, filed on Dec. 14, 2012.

(51) Int. Cl. G06F 3/041

(52) U.S. Cl. CPC G06F 3/0416; G06F 3/041
USPC 345/173

(57) ABSTRACT

The systems and methods disclosed herein provide for an electronic border that dynamically appears and disappears in an electronic display screen of a mobile device, such as a tablet computer, smart phone, laptop, and/or other mobile device. In an embodiment, the mobile device comprises an electronic display screen that is sized to fit the entire and/or substantially the entire, length and width of the face of the mobile device. The system can also be configured to display an electronic border along the edges of the mobile device

### CROSS REFERENCE TO RELATED APPLICATIONS

This application claims the benefit of U.S. Provisional Patent Application Ser. No. 61/737,278, filed Dec. 14, 2012, entitled “DYNAMIC BORDER CONTROL SYSTEMS AND METHODS,” which is hereby incorporated herein by reference in its entirety.

### BACKGROUND

1. Field

The disclosure relates generally to the field of computing devices, and more particularly, to the field of dynamic border control systems on mobile computing devices.

2. Description

With the development of new technologies, such as tablet computing devices, smartphones and other mobile computing devices, users now have the ability to access data on various computing platforms. Not only can data be accessed on various computing platforms, but also data can now be accessed by users from a variety of locations. For example, user need not be at the office to access data. By using a tablet computer, smartphone, or other mobile device, a user can access data outside of the office so long as the user has a network connection for the mobile device. Increasingly, users are not located at the office and are more often than not out of the office visiting clients or the like. Therefore, there is a growing demand for accessing data on mobile devices.

However, mobile devices typically are constrained in the amount of data that can be presented to the user. For example, mobile devices generally have smaller electronic display screens than the electronic display connected to a user's computer system at the office. Smaller screens are often required by mobile devices because such devices often need to be physically compact and portable for a user and/or must be supported by a reasonable battery to power an electronic display screen. Accordingly, there is a need for a system that will allow for maximizing display screens for presenting to the user the maximum amount of data possible, while maintaining or reducing the size of mobile devices.

### SUMMARY

Advancements in technology make it possible to implement a dynamic border control system on a computing device, thereby allowing display screen size to increase while maintaining or reducing the physical size of the computing device.

In some embodiments, a computer-implemented method for controlling a dynamic border of a mobile computing device, the computer-method being implemented by a physical processor of the mobile computing device, can include receiving, by the physical processor, a sensor signal indicating detection of a user contact or a user input for triggering deactivation of an edge portion of a display screen of the mobile computing device, and deactivating, by the physical processor, the edge portion of the display screen in response to the user contact or user input.

In some embodiments, deactivating the edge portion of the display screen can include displaying a colored border on the display screen, where the colored border corresponds to the deactivated edge portion of the display screen. In some embodiments, deactivating the edge portion of the display screen can include deactivating a series of display pixels along an edge of the display screen. Deactivating the series of display pixels may include shutting off the series of display pixels.

In some embodiments, the method can include receiving, by the physical processor, a user contact duration signal indicating a duration of the user contact, where deactivating the edge portion of the display screen includes deactivating the edge portion in response to a user contact that is longer than a threshold duration of time.

In some embodiments, the method can include selecting a border profile by the physical processor, where the border profile defines at least one of a dimension of the deactivated edge portion of the display screen and a location on the display screen of the deactivated edge portion. Selecting the border profile may include selecting a width of the deactivated edge portion based on a detected width of the user contact. In some embodiments, the method can include selecting a different border based on a change in the detected width of the user contact.

In some embodiments, the sensor signal can indicate detection of a user contact on a backside of the mobile computing device. In some embodiments, the user input can include an input to select a border profile for deactivating the edge portion of the display screen.

A system for controlling a dynamic border of a mobile computing device can include a non-transitory computer-readable medium having instructions encoded thereon that, in response to execution by a physical processor of the system, causes the physical processor of the system to receive a sensor signal indicating detection of a user contact or a user input for triggering deactivation of an edge portion of a display screen of the mobile computing device, and to deactivate the edge portion of the display screen in response to the user contact or user input.

In some embodiments, the mobile computing device can include an accelerometer and where the physical processor can be configured to receive an angle sensor signal from the accelerometer. The physical processor may be configured to activate a deactivated edge portion of the display screen if the angle sensor signal indicates that the mobile computing device is in a substantially horizontal position.

In some embodiments, the physical processor can be configured to receive a signal indicating the mobile computing device is docked onto a docking station, where the physical processor can be configured to activate a deactivated edge portion of the display screen in response to the signal.

In some embodiments, the physical processor can be configured to ignore user input in the deactivated edge portion of the display screen.

In some embodiments, the physical processor can be configured to display a border on the display screen, where the border corresponds to the deactivated edge portion of the display screen.

In some embodiments, the system can include a front side detector for detecting a user contact width. The physical processor may be configured to select a border profile for the deactivated edge portion of the display screen based on the user contact width, where the border profile defines a width of the deactivated edge portion.

In some embodiments, the system can include a front side detector for detecting a duration of a substantially stationary user contact. The physical processor may be configured to deactivate the edge portion in response to a user contact that is substantially stationary for a duration longer than a threshold period of time.

A system for controlling a dynamic border of a mobile computing device can include, a display apparatus having a display screen, a display apparatus control configured to provide control instructions to the display apparatus for deactivating an edge portion of the display screen of the display apparatus, at least one detector for detecting a sensor signal indicating a user contact or a user input configured to trigger deactivation of the edge portion of the display screen, and a non-transitory computer-readable medium having instructions encoded thereon that, in response to execution by the display apparatus control, causes the display apparatus control to generate the control instructions based on the sensor signal to deactivate the edge portion of the display screen. The at least one detectors can include at least one of a front side panel detector configured to detect user contact on a front side panel of the mobile computing device, a back side panel detector configured to detect user contact on a back side panel of the mobile computing device, a user control detector configured to detect manual user control input, an application detector configured to detect whether applications for triggering deactivation of the edge portion are running on the mobile device, a docking detector configured to detect whether the mobile computing device is docked onto a docking station, and an accelerometer detector configured to detect an angle at which the mobile computing device is positioned.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the embodiments of the invention are described in detail below with reference to the drawings of various embodiments, which are intended to illustrate and not to limit the embodiments of the invention. The drawings comprise the following figures in which:

FIG. 1 is an embodiment of a schematic diagram illustrating a computing device having a display area.

FIG. 2 is an embodiment of a schematic diagram illustrating a computing device with a dynamic border control system.

FIG. 3 is an embodiment of a schematic diagram illustrating a computing device with a dynamic border control system configured to be activated by user input.

FIG. 4 is an embodiment of a schematic diagram illustrating a computing device having a dynamic border control system.

FIG. 5 is an embodiment of a schematic diagram illustrating a computing device having a dynamic border control system.

FIG. 6 is a block diagram depicting a high level overview of an embodiment of a dynamic border control system.

FIG. 7 is a flow chart depicting an embodiment of a process for controlling a dynamic border control system.

FIG. 8 is a flow chart depicting an embodiment of a process for controlling a dynamic border control system.

FIG. 9 is a flow chart depicting an embodiment of a process for controlling a dynamic border control system connected to a plurality of detectors and other inputs.

FIG. 10 is a block diagram depicting an embodiment of a computer system configured to run software for implementing one or more embodiments of the dynamic border control system described herein.

### DETAILED DESCRIPTION

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practicing the inventions herein described.

With the development of new mobile device technologies, such as tablet computing devices, smartphones, laptops, netbooks, GPS devices, kiosks, and other mobile devices and electronic device interfaces, users are increasingly relying solely on such computing devices to access critical data and/or to control complex functions and/or to communicate important messages to others. However, as more and more users are utilizing such mobile devices, many users face a challenge in viewing data on such compact devices having small electronic display screens. Tablets, smartphones, and other mobile computing devices are a balance between overall physical size and visible display area.

Generally, users desire a small form factor for the overall physical size of the mobile device, while also wanting a large screen display in order to provide sufficient “real estate” for viewing data. Additionally, physical buttons and/or switches, camera lenses, speakers, microphones, flash bulbs and other lights, and port openings, can generally decrease the amount of space available for a display on a mobile device. For example, on the face of a mobile device there is only a certain amount of space, also known as “real estate”, for positioning an electronic display screen as well as physical buttons and the like.

In order to accommodate all of these features of a mobile device, engineers may decrease the electronic display screen size in order to provide sufficient space for physical buttons and other features. However, the reduction of display screen sizes can limit the available visible display area for showing critical data to a user. One possible solution to this challenge is to make the mobile device physically bigger in size. However, many users prefer their mobile devices to be small and compact for easy transport and storage. Accordingly, there is a dichotomy between a small form factor and large screen size.

Another solution to providing a maximum screen size within a small, compact physical device is to engineer a mobile device wherein the electronic display screen is sized to fit the entire, or substantially entire, face of the mobile computing device. In such a configuration, the electronic display screen spans the entire, or substantially entire, length and width of the face of the mobile device. Accordingly, this solution enables the screen size to be expanded while maintaining the same physical size of the mobile device.

However, the challenge with such a design configuration is that the electronic display screen in this type of setup is configured to display data along the edges of the physical mobile device. Displaying data along the edges of the mobile device can be problematic when a user attempts to hold the device with the fingers of the user. Typically, a user will place a thumb on the front face of the mobile device while placing the one or more other fingers on the back side of the mobile device in order to grasp or hold on to the device while reading data from the device. With a thumb placed along one or more of the edges of the front face of the mobile device, critical data can be covered up or obscured, thereby necessitating the user to reposition the thumb to a different part of the mobile device, for example, a side edge of the device, which can be uncomfortable and/or precarious for securely gripping the device.

Additionally, the electronic display screen on many mobile devices comprises a touch screen to enable the detection of a user's input on the screen. By expanding the electronic display screen to the edges of the mobile device, the placement of a thumb or other finger along the edges of the front face of the mobile device can provide false input into the system. Many mobile device engineers have avoided these challenges by reducing the screen size and/or placing a border, for example, plastic or glass, along the edges or perimeter front face of the mobile device. In many instances, the border is simply a plastic rim that surrounds an electronic display screen. However, by reducing the electronic display screen size, there is a reduction in the amount of viewable display area for showing critical data to the user.

To solve the foregoing challenges, the systems and methods disclosed herein provide for a electronic border that dynamically appears and disappears in an electronic display screen of a mobile device, such as a tablet computer, smartphone, laptop, and/or other computing device. In an embodiment, the mobile device comprises an electronic display screen that is sized to fit the entire, or substantially the entire, length and width of the face of the mobile device. The system can also be configured to display an electronic border along the edges of the mobile device.

The terms “mobile device” or “computing device” are broad interchangeable terms as used herein unless their context suggests otherwise, and generally refer to computing devices, including but not limited to tablet computing devices, electronic readers, smartphones, laptops, netbooks, GPS devices, game consoles, kiosks, and the like.

The terms “border” or “electronic border” as used herein, are broad terms that generally refers to the generation of an electronic border along the edge of a mobile device using the pixels in the electronic display screen that is sized to fit the entire, or substantially entire, length and width of the mobile device.

To generate the electronic border, the system can be configured a number of different ways. For example, the system can be configured to display a uniform color of pixels having a set or specific width along the entire edge of the mobile device. Specifically, the system can be configured to display pixels to show the color black or grey along the edge of the mobile device in order to create an electronic border. In an embodiment, the system can be configured to display an electronic border utilizing other colors, such as white, red, blue, green or the like, textures, patterns, backgrounds, images, or the like.

Alternatively, the system can be configured to generate an electronic border by dynamically deactivating and/or activating a series of pixels along the edge of the mobile device. For example, the system can be configured to deactivate and/or shut off the first N pixels from the edge of the electronic display screen along the entire edges of the mobile device, wherein N can range from 1 to 5000, depending on the pixel density of the electronic display screen. By deactivating or shutting off these pixels, the display screen will show essentially a grayed or blacked out area along the edges of the entire electronic display screen in order to generate an electronic border. This configuration can also be advantageous because the deactivation of pixels can reduce energy usage by the computing device to power the electronic display screen, which can in turn extend the battery charge of a mobile computing device. This conservation of energy can be beneficial to users because it can allow the user to reduce the number of times the user needs to recharge the mobile computing device.

In an embodiment, the system can also be configured to deactivate and/or shut off the touch screen within the electronic border areas. By deactivating or shutting off the touch screen in the electronic border areas, the system can avoid receiving false input from the fingers of the user that are holding onto the mobile device. Alternatively, the system can be configured to ignore user input received in the electronic border areas thereby also limiting the amount of false input received by the system.

For example, when the user is holding on to the mobile device by placing a thumb around or near the edge of the front face of the mobile device within the electronic border area, the system can be configured to deactivate or shut off the touch screen in the electronic border area or ignore the user input received by the thumb of the user touching the touch screen in the electronic border area. Alternatively, the system can be configured to deactivate a portion of the touch screen without displaying the electronic border and while showing the entire display screen area. For example, the system can be configured to narrow the active touch screen area without narrowing display area. In other words, the system can be configured to ignore touch inputs from the user in areas along the edges of the electronic display screen while allowing for a maximum display area.

In an embodiment, the electronic border system is configured to appear and disappear dynamically based on user input. For example, the system can be configured to deactivate or not display the electronic border when the mobile device is resting on a table or is propped up on a stand. In contrast, the system can be configured to activate or display an electronic border when the user picks up the mobile device in a user's hands.

This configuration can be advantageous because when the mobile device is resting on a table and/or propped up on a stand, the electronic display screen is configured to display the maximum amount of data to the user because the electronic border is removed. This configuration is further advantageous because when the mobile device is picked up in the hands of a user, the system is configured to activate or display an electronic border in order for the user to touch the sides of the mobile device without covering up critical data elements and/or providing false input to the mobile device.

The system can be configured to activate and deactivate the electronic border through a variety of inputs. In an embodiment, the system can be configured to detect using the touch pad on the face of the mobile device when a user's thumb is positioned along the edge of the mobile device. By detecting a thumb along the edge of the front face of the mobile device, the system can be configured to display an electronic border. In an embodiment, the system can be configured to detect a thumb positioned along the edge of the face of the mobile device for an extended period of time. For example, the system can be configured to display an electronic border in the event that the system detects a thumb placed on the front face of the mobile device for a period of time, for example, five seconds or the like.

In an embodiment, the mobile device comprises a touch screen or other detector on the back face of the mobile device in order to detect the fingers of the user grasping the mobile device. By detecting fingers contacting the back face of the mobile device, the system can be configured to display an electronic border. Alternatively, the system can be configured to deactivate or not display the electronic border when the system only detects one or more fingers in contact with the back face of the computing device. In an embodiment, the system can be configured to use the detectors on the back face (or alternatively on the front face) of the computing device to detect a finger gesture or swipe from the user that controls when the system deactivates or activates the electronic border. For example, the system can be configured to deactivate the electronic border when one or more fingers of the user are moved from a more middle portion of the back face to an edge portion of the back face of the computing device. Alternatively, the system can be configured to allow the user to deactivate or not show the electronic border in order to display the full screen by inputting a finger gesture control, for example, by spreading two fingers or spreading thumbs on both sides of the display or moving thumbs laterally. In an embodiment, the system can be configured to display an electronic border based on detecting both contact on the front face and the back face of the mobile device.

In an embodiment, the mobile device comprises an electronic switch and/or an actual physical switch through which the user can provide input to the system in order to activate or deactivate the electronic border on command. In an embodiment, the system can be configured to activate or deactivate an electronic border based on detecting whether the mobile device has been docked into a docking station. For example, the system can be configured to display an electronic border when the system detects that the mobile device has been docked into a docking station.

In an embodiment, the system can be configured to display an electronic border based on application input. For example, the system can be configured to display or not display an electronic border when a certain application is operating on the mobile device.

In an embodiment, the system can be configured to activate or deactivate an electronic border based on detecting the angle of the mobile device based on input from an accelerometer. For example, the system can be configured to deactivate an electronic border when the accelerometer detects that the angle of the mobile device is zero degrees relative to the ground or is substantially horizontal. When the mobile device is angled at zero degrees or is substantially horizontal, the system assumes that the mobile device is resting on a table and therefore an electronic border should not be displayed. In an alternative embodiment, the system can be configured to comprise detectors on the rear face of the computing device, wherein the rear detectors are configured to sense a proximity to a surface facing the rear face of the computing device. Alternatively, the system can be configured to display an electronic border when the accelerometer detects that the mobile device is at an angle other than zero degrees or other than substantially horizontal.

In an embodiment, the system can be configured to deactivate an electronic border when the mobile device is connected to a peripheral device, for example a keyboard, a mouse, track pad, pointing device, remote control device, audio device, or the like.

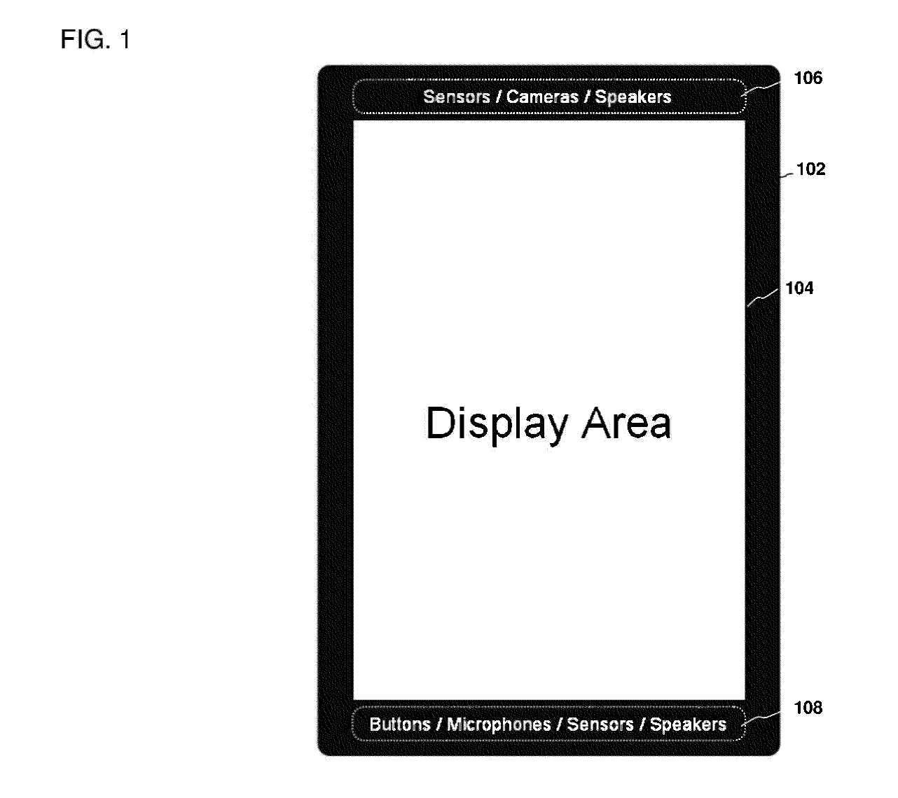

FIG. 1 is an embodiment of a mobile device. The mobile device 102 can comprise a display area 104. In an embodiment, the mobile device can comprise sensors, cameras, speakers, or the like 106. In an embodiment, the sensors, cameras, speakers, or other components 106 can be integrated within the electronic display screen 104. In an embodiment, the mobile device 102 can comprise physical buttons, microphones, other sensors, and additional speakers 108. The foregoing features can also be integrated into the electronic display screen 104 or the features 108 can be positioned in the mobile device separate from the electronic display screen 104.

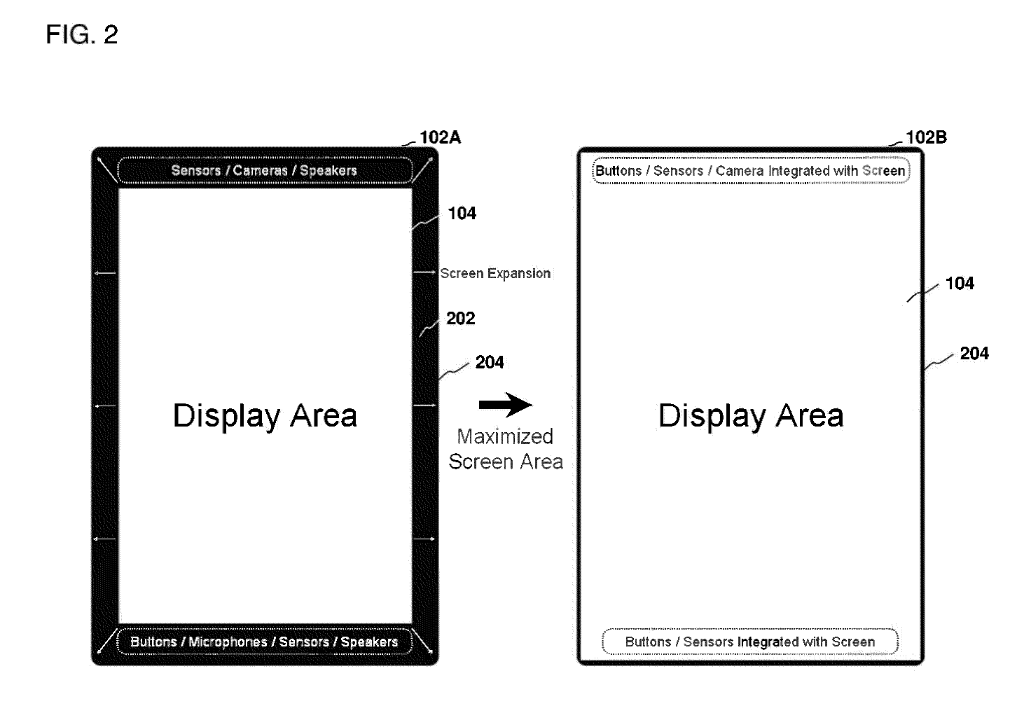

FIG. 2 is an embodiment of a schematic diagram illustrating a mobile device 102 configured to display an electronic border 202. As illustrated, the mobile device 102A has activated the electronic border to be displayed to the user. The electronic border has decreased the available display area 104 to accommodate the display of the electronic border 202. In an embodiment, the shrinkage of the display area causes the content in the display area to be resized proportionally. Alternatively, the system can be configured to maintain the content in the same size ratio and/or aspect ratio while cutting off or not displaying content along the edges of the display area.

In an embodiment, the user may be able to access the cutoff content by scrolling over to the edges of the mobile device or by moving the thumb or other finger of a user off the front face of the computing device. As illustrated in the mobile device 102B, the display area 104 has been expanded by removing the electronic border 202. In such a configuration, the display area 104 is capable of displaying content in the display area 104 along the edge of the mobile device 204.

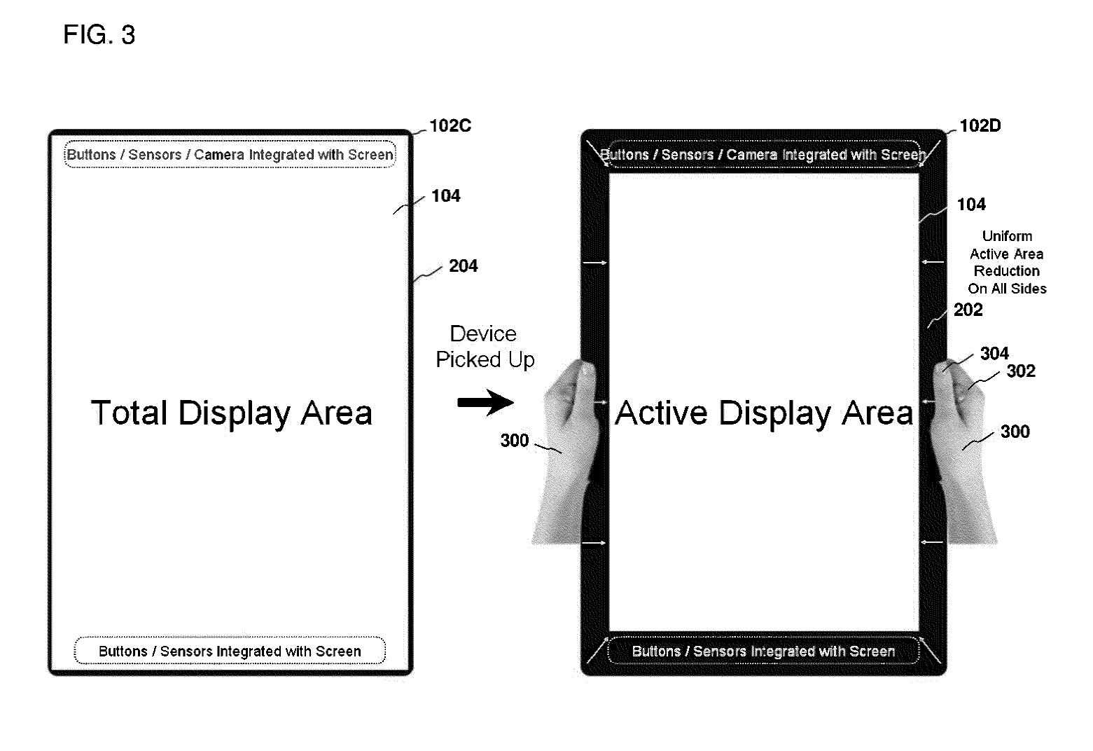

FIG. 3 is an embodiment of a schematic diagram illustrating the mobile device 102 that has been picked up by a user's hands 300. As illustrated, the mobile device 102C shows a total display area 104 that has been expanded to the edges 204 of the mobile device by deactivating the electronic border 202. As illustrated, the mobile device 102D has been picked up by the hands 300 of the user. In an embodiment, the system is configured to display or activate the electronic border 202 when the system detects that the hands of the user have contact with the mobile device 102D.

In an embodiment, the system is configured to detect using the touch screen of the mobile device 102D whether a thumb 304 of the user is contacting the front face of the mobile device 102D. Based on detecting the thumb 304 on the face of the mobile device, the system can be configured to activate or show the electronic border 202.

In an embodiment, the system can be configured to detect when one or more fingers 302 are in contact with the back side of the mobile device. Based on detecting one or more fingers in contact with the back side of the mobile device 102D, the system can be configured to activate or display an electronic border 202. In an embodiment, the system can be configured to display or activate an electronic border 202 based on detecting both a thumb or other finger 304 on the front face of the mobile device 102D and on the detection of one or more fingers 302 placed on the back side of the mobile device 102D.

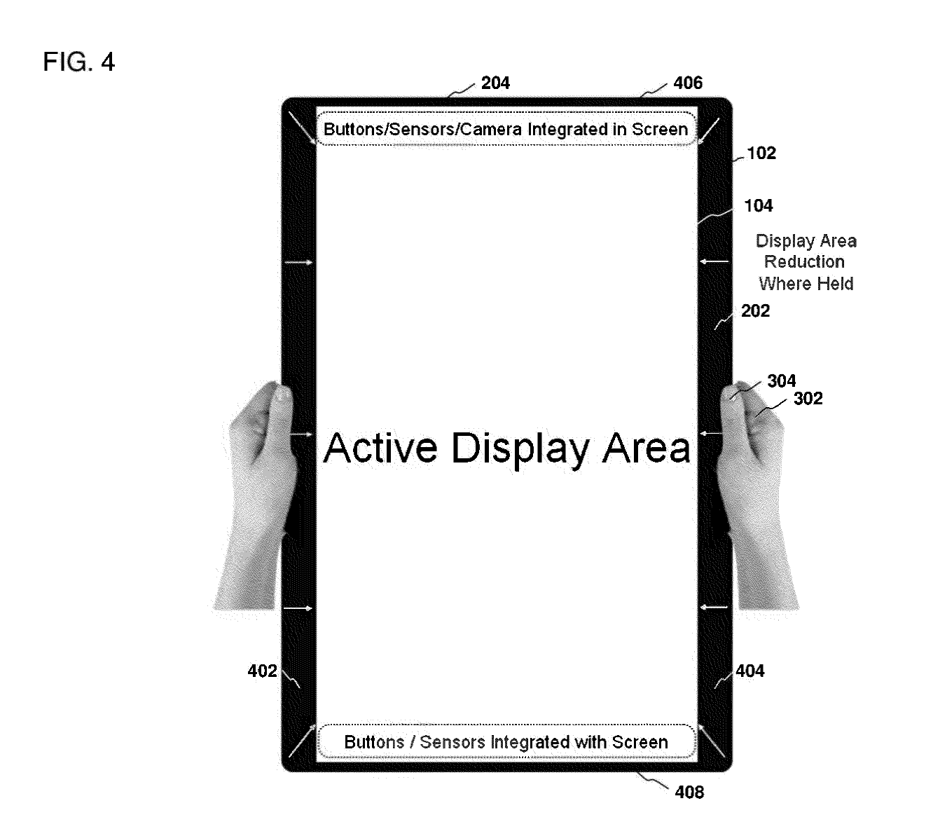

FIG. 4 is an embodiment of a schematic diagram illustrating a mobile device displaying an electronic border. Similar to the embodiments disclosed above, the mobile device 102 can be configured to display or activate an electronic border 202 based on detection of one or more thumbs 304 and/or fingers 302 placed on the front and/or back sides of the mobile device. In contrast to the embodiments above, the system can also be configured to display a part of the electronic border 202. As illustrated in FIG. 4, the mobile device 102 can be configured to only display the left and right lengthwise sides 402, 404 of the mobile device 102. This configuration can be advantageous because the system can further maximize the size of the display area 104 by displaying content all the way to the edges 204 of the mobile device at both the top and bottom short sides 406, 408 of the mobile device. While displaying or activating the electronic border along the left and right lengthwise sides 402, 404 of the mobile device.

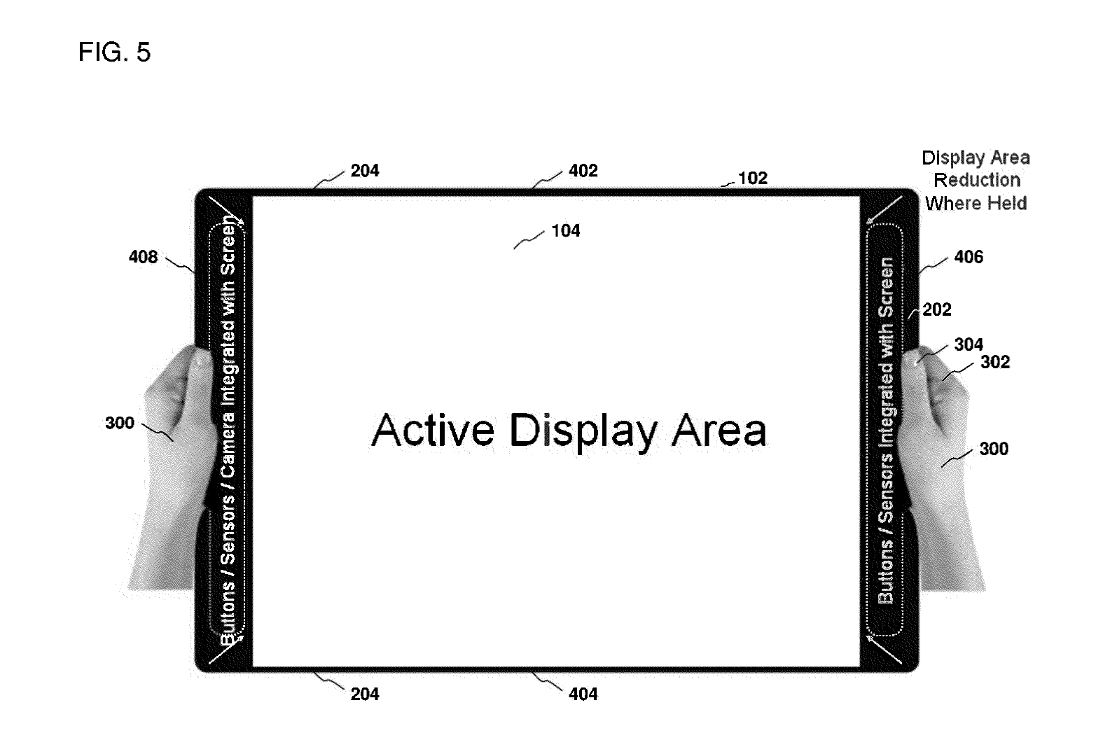

FIG. 5 is an embodiment of a schematic diagram illustrating the mobile device showing an electronic border. Similar to the embodiment illustrated in FIG. 4, this system can be configured in certain embodiments to display a part of the electronic border. In contrast to the embodiment illustrated in FIG. 4, the embodiment illustrated in FIG. 5 shows the mobile device 102 rotated 90° such that the lengthwise sides 402, 404 are oriented at the top and bottom of the mobile device 102.

As illustrated in FIG. 5, the hands 300 of the user are grasping the short sides 406, 408 of the mobile device 102. In an embodiment, the system is configured to activate or display the electronic border 202 along the short sides 406, 408 of the mobile device 102. This system can also be configured to expand the display area 104 to the edges 204 of the long sides 402, 404 of the mobile device 102 while reducing the display area 104 along the short sides 406, 408 to accommodate the display of the electronic border 202.

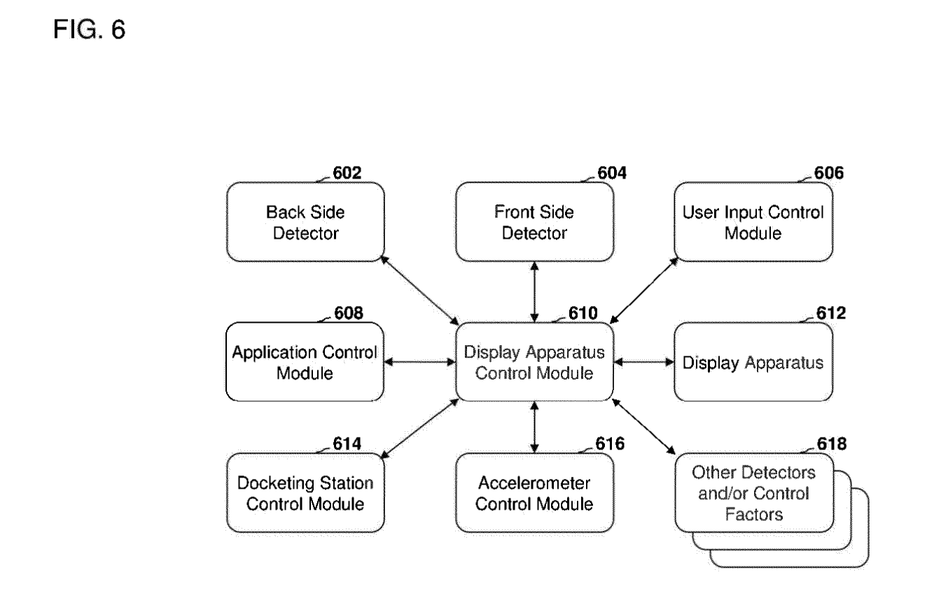

FIG. 6 is a block diagram depicting a high level overview of an embodiment of a dynamic border control system. In an embodiment, the system can comprise a display apparatus control module 610 that is connected to a display apparatus 612. The display apparatus control module 610 can be configured to control when to activate or deactivate or show or not show an electronic border on the display apparatus 612. The display apparatus control module 610 can be coupled to a number of detectors and/or other modules to receive input necessary to determine when to activate or deactivate the electronic border.

In an embodiment, the display apparatus control module 610 is coupled to a front side detector 604 and/or a back side detector 602. In an embodiment, the front side detector 604 and/or the back side detector 602 comprises a touch screen that is positioned on the front and/or back sides of the mobile device 102. The detectors 604, 602 can be configured to determine when one or more fingers of a user are in contact with the mobile device. In an embodiment, the display apparatus control module 610 is connected to a user input control module 606. The user input control module 606 can comprise electronic buttons and/or physical buttons on the mobile device 102. The user input control module 606 can be configured to receive user input that represents instructions from the user to activate or deactivate the electronic border in the display apparatus 612.

In an embodiment, the display apparatus control module 610 can be connected to application control module 608. The application control module 608 can be configured to receive and/or access and/or detect whether a particular type of software application is running on the mobile device. Based on detecting the operation of certain software applications running on the mobile device, the application control module 608 can cause or instruct the display apparatus control module 610 or deactivate or activate the electronic border on the display apparatus 612.

In an embodiment, the display apparatus control module 610 is connected to a docking station control module 614. The docking station control module 614 can be configured to determine when the mobile device 102 is connected to a docking station. Based on detecting that the mobile device is docked to a docking station, the docking station control module 614 can be configured to instruct the display apparatus control module 610 to deactivate or activate the electronic border in the display apparatus 612.

In an embodiment, the display apparatus control module 610 can be connected to an accelerometer control module 616. The accelerometer control module 616 can be configured to receive data from an accelerometer detector to determine the angle in which the mobile device is positioned. Based on the detected angle of the mobile device 102, the accelerometer control module 616 can instruct the display apparatus control module to activate or deactivate the electronic border in the display apparatus 612.

In an embodiment, the display apparatus control module 610 can be connected to other detectors and other control factors 618 in order to deactivate or activate the electronic border in the display apparatus 612 based on other control factors.

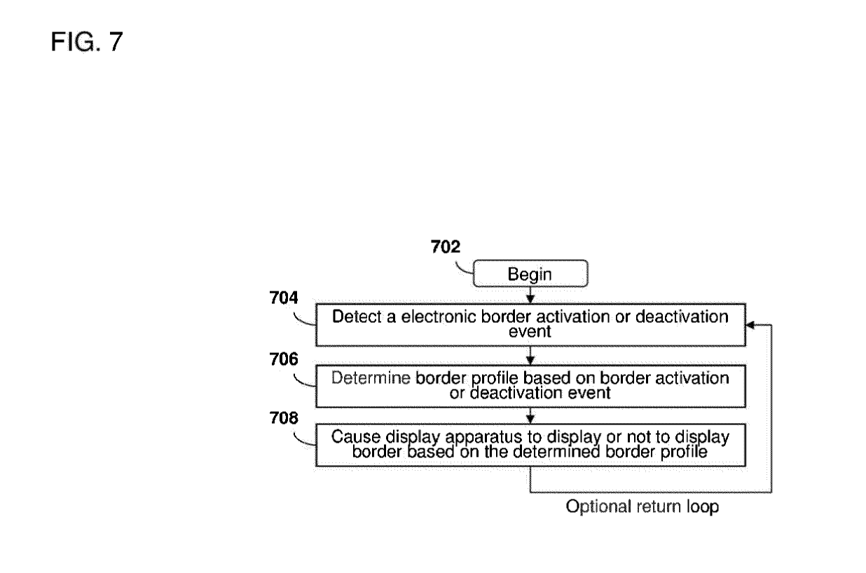

FIG. 7 is a flow chart depicting an embodiment of a process for deactivating or activate an electronic border. At block 702 the process can begin by detecting a border activation or deactivation event at block 704. As disclosed herein, an electronic border activation or deactivation event can be based on a variety of control factors. For example, an electronic border activation or deactivation event can comprise the detection of one or more fingers placed on the front and/or back sides of a mobile device.

At block 706, the system can be configured to determine a border profile to be displayed on the electronic display screen of the mobile device based on the electronic border activation or deactivation event. At block 708, the system can be configured to cause the electronic display screen of the mobile device to display and/or not to display an electronic border based on the determined border profile. Optionally, the system can be configured to return back to block 704 to detect a subsequent electronic border activation or deactivation event.

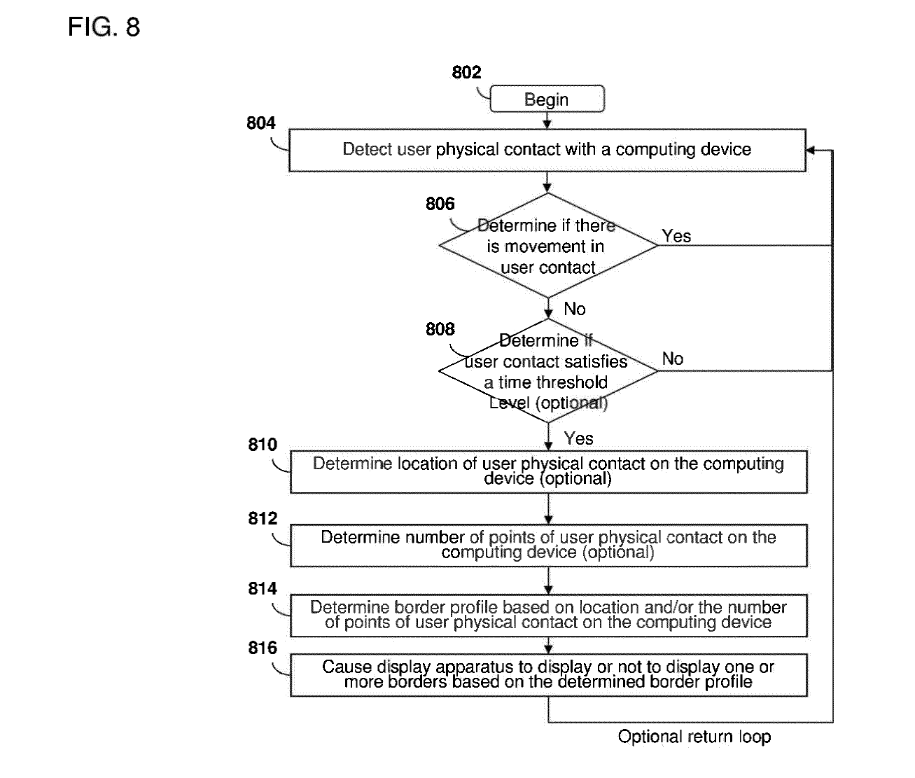

FIG. 8 is a flow chart depicting an embodiment of a process for controlling an electronic border system. The process can begin at block 802 wherein the system can be configured to detect physical contact by the user with the mobile device. At decision block 806, the system can be configured to determine whether there is movement in the user contact. If there is movement in the user contact, then the system can be configured to assume that the contact by the user with the mobile device is a finger gesture command to the mobile device. If the user contact is a finger gesture command, then the system is configured to not display an electronic border. Optionally, the system can be configured to return back to block 804 to wait for a detection of other user physical contact with the mobile device.

If the contact by the user with the mobile device is stationary or substantially stationary then the system can be configured to assume that the user contact is primarily for holding the mobile device in the user's hand. The system can then be configured to move to decision block 808 to determine if the stationary user contact satisfies a time threshold level. For example, the system can determine whether the user contact has been stationary or substantially stationary for a specific period of time, such as five seconds. If the user contact has not been stationary or substantially stationary for a period of time then the system can be configured to return back to block 804 to wait and detect other user physical contact with the mobile device.

If the user contact is stationary for a period of time to satisfy the threshold level, then the system can be configured to move the block 810. At block 810, the system can be configured to determine the location of the user physical contact on the mobile device. This optional block can provide useful information to the system to determine whether the user physical contact is along the sides of the mobile device within the border section. In an embodiment, the system can be configured to utilize the location information in order to dynamically size the electronic border width to ensure that the electronic border is sufficiently wide enough to accommodate the fingers of the user that are positioned on the mobile device. Alternatively, the system can be configured to dynamically size the width and/or height of the electronic border depending upon where the user places his/her fingers on the computing device, for example, the one or more fingers can be positioned on a wider or narrower portion of the computing device.

At block 812, the system can be configured to optionally determine the number of points of user physical contact on the computing device. For example, if the system detects only one point of user physical contact on the mobile device, then the system can be configured not to display an electronic border. Alternatively, if the system detects that there are two or more points of physical user contact on the mobile device, then the system can be configured to display an electronic border.

At block 814, the system can be configured to determine the proper border profile based on the location and/or the number of points of user physical contact on the mobile device. At block 816, the system can be configured to cause the display apparatus to display or not to display one or more electronic borders based on the determined border profile. The system can optionally return to block 804 to wait and/or detect for new user contact with the mobile device.

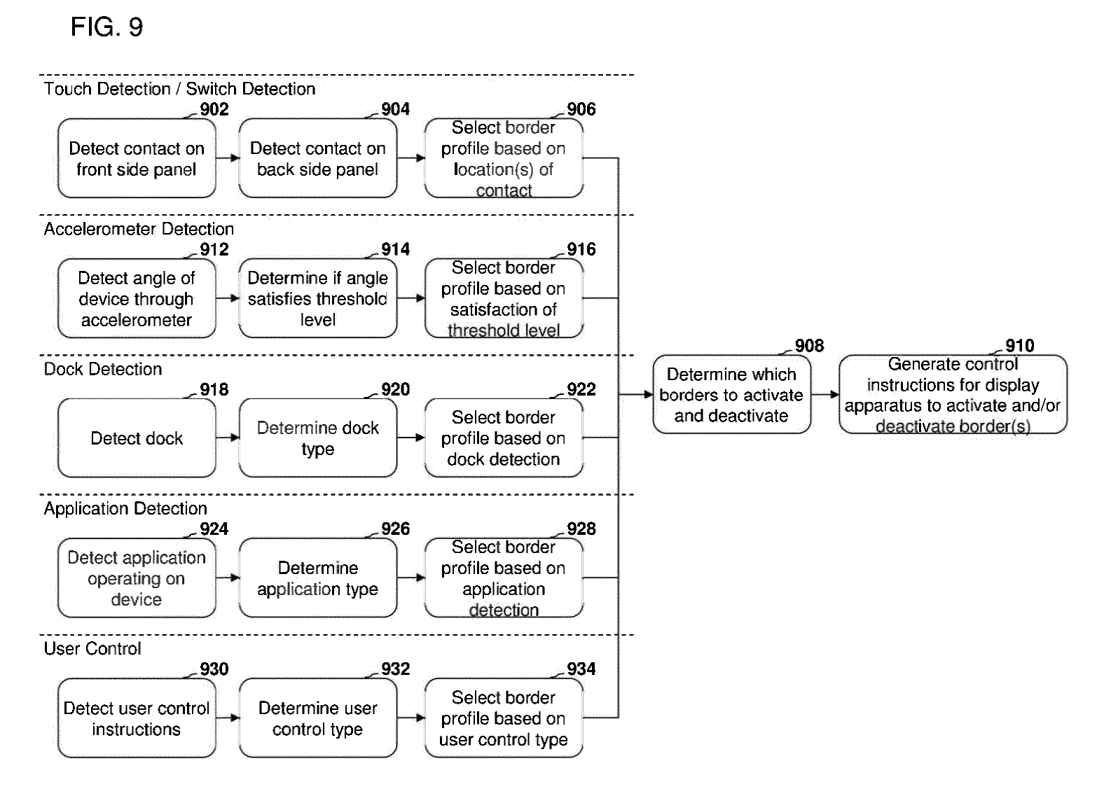

FIG. 9 is a flow chart depicting an embodiment for controlling an electronic border system. In an embodiment, the dynamic border control system can include a plurality of detectors and other inputs. In some embodiments, the dynamic border control system can include one or more touch detectors. For example, the dynamic border control system can include one or more touch detectors on a front side panel of a mobile device, and/or one or more touch detectors on a back side panel of a mobile device. At block 902, the one or more touch detectors on the front side panel of the mobile device can detect user contact on the front side panel. At block 904, the one or more detectors on the back side panel of the mobile device can detect user contact on the back side panel of the mobile device. Information regarding user contact can be provided to a display apparatus control of the dynamic border control system. At block 906, the display apparatus control can select a border profile based on location of user contact. For example, the display apparatus control can select a border profile based on the locations of user contact on the front side panel and/or the back side panel of the mobile device.

In some embodiments, the dynamic border control system can include one or more accelerometers. At block 912, the one or more accelerometers can detect an angle at which the mobile device is positioned. Information regarding the angle at which the mobile device is positioned can be provided to a display apparatus control of the dynamic border control system. At block 914, the display apparatus control can determine whether the detected angle satisfies a threshold angle level. For example, if detected angle is greater than, or less than, a threshold value, the display apparatus control can proceed to generate instructions for activating a border on the mobile device display screen. In some embodiments, the display apparatus control can proceed to generate instructions for activating a border on the mobile device display screen if the detected angle is zero or substantially zero relative to ground (e.g., indicating the mobile device is lying horizontally). At block 916, the display apparatus control can select a border profile if the detected angle at which the mobile device is positioned satisfies the threshold angle level.

In some embodiments, the dynamic border control system can include one or more docking detectors. At block 918, the one or more docking detectors can detect whether the mobile device is docked onto a docking station. In some embodiments, the docking detectors can detect the type of docking station the mobile device is docked onto. Information regarding whether the mobile device docked onto a docking station and/or the type of docking station onto which the mobile device is docked can be provided to a display apparatus control of the dynamic border control system. For example, if the one or more docking detectors detect that the mobile device is docked onto a docking station, the one or more docking detectors can provide a signal to the display apparatus control to indicate that the mobile device is docked, and/or information relating to the type of the docking station onto which the mobile device is docked. At block 920, the display apparatus control can determine the type of docking station onto which a mobile device is docked. At block 922, the display apparatus control can select a border profile based on whether the mobile device is docked into a docking station, and/or the type of docking station onto which the mobile device is docked.

In some embodiments, the dynamic border control system can include one or more application detectors. At block 924, the one or more application detectors can detect whether one or more applications are currently running on the mobile device (e.g., whether applications which should trigger activation of a border on the mobile device display screen). In some embodiments, the one or more application detectors can be configured to detect additional information relating to the one or more applications that are currently running on the mobile device, such as information relating to which application it is that is running, and/or information relating to a type of the application that is running (e.g., if the application is of a type which should trigger activation of a border on the mobile device display screen). Information relating to the applications can be provided to a display apparatus control of the dynamic border control system by the application detectors. At block 926, the display apparatus control can determine the type of application and/or types of applications that the mobile device is running. At block 928, the display apparatus control can select a border profile based on information provided by the one or more application detectors. For example, the display apparatus control can select a border profile based on whether the mobile device is currently running certain applications, and/or based on additional information relating to the certain applications that are running on the mobile device (e.g., based on information relating to the identity and/or information relating to a type and/or types of the certain applications that are running on the mobile device).

In some embodiments, the dynamic border control system can include one or more user controls configured to receive user input relating to activation of a border on a display screen of the mobile device. The user control can facilitate manual input from a user relating to a desired border selection for the display screen. At block 930, the one or more user controls can be configured to detect user control instructions relating to activation of the border. In some embodiments, the user control instructions can relate to whether a border is desired, a type of border that is desired, and/or other information relating to the border which can be activated in response to the user control instructions. The user control instructions can be provided to the display apparatus control by the one or more user control detectors. At block 932, the display apparatus control can determine the type of user control input detected by the one or more user controls. At block 934, the display apparatus control can select a border profile based on the type of user control input.

At block 908, the display apparatus control can determine which border to activate and/or deactivate using the one or more border profiles selected by the display apparatus control based on input from the one or more touch detectors, the one or more accelerometer detectors, the one or more docking station detectors, the one or more application detectors, and/or the one or more user controls. In some embodiments, the display apparatus control can determine which border to activate and/or deactivate using one border profile selection. In some embodiments, the display apparatus control can determine which border to activate and/or deactivate using more than one border profile selection. At block 910, the display apparatus control can generate control instructions for the display apparatus of the mobile device relating to the activation and/or deactivation of one or more borders on the display screen of the mobile device.

Computing System

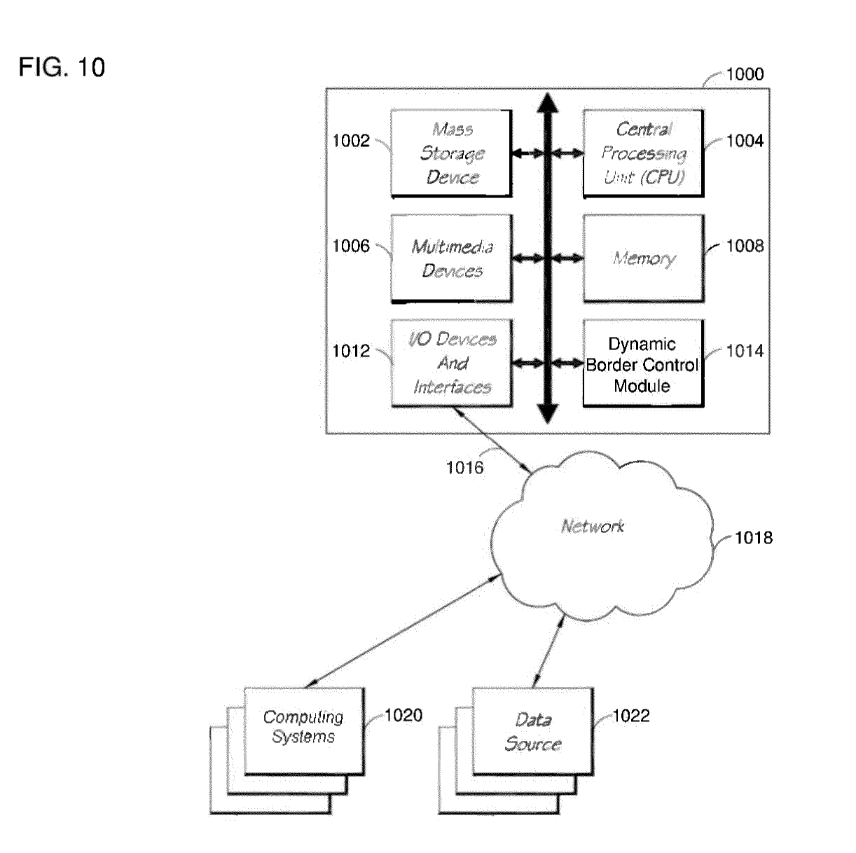

In some embodiments, the computer clients and/or servers described above take the form of a computing system 1000 illustrated in FIG. 10, which is a block diagram of one embodiment of a computing system that is in communication with one or more computing systems 1020 and/or one or more data sources 1022 via one or more networks 1018. The computing system 1000 may be used to implement one or more of the systems and methods described herein. In addition, in one embodiment, the computing system 1000 may be configured to apply one or more of the dynamic electronic border control methods and systems described herein. While FIG. 10 illustrates an embodiment of a computing system 1000, it is recognized that the functionality provided for in the components and modules of computing system 1000 may be combined into fewer components and modules or further separated into additional components and modules.

Dynamic Electronic Border Control System

In an embodiment, the system 1000 comprises a dynamic electronic border control system module 1014 that carries out the functions described herein with reference to controlling one or more dynamic electronic borders, including any one of the electronic border control methods described above. The dynamic electronic border control system module 1014 may be executed on the computing system 1000 by a central processing unit 1004 discussed further below.

In general, the word “module,” as used herein, refers to logic embodied in hardware or firmware, or to a collection of software instructions, possibly having entry and exit points, written in a programming language, such as, for example, COBOL, CICS, Java, Lua, C or C++ or Objective C. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

Computing System Components

In an embodiment, the computing system 1000 also comprises an iPhone®, iPad®, or other computing devices suitable for controlling and/or communicating with large databases, performing transaction processing, and generating reports from large databases. The computing system 1000 also comprises a central processing unit (“CPU”) 1004, which may comprise a conventional microprocessor. The computing system 1000 further comprises a memory 1008, such as random access memory (“RAM”) for temporary storage of information and/or a read only memory (“ROM”) for permanent storage of information, and a mass storage device 1002, such as a hard drive, diskette, or optical media storage device. Typically, the modules of the computing system 1000 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 1000 comprises one or more commonly available input/output (I/O) devices and interfaces 1012, such as a keyboard, mouse, touchpad, and printer. In one embodiment, the I/O devices and interfaces 1012 comprise one or more display devices, such as a monitor, that allows the visual presentation of data to a user. More particularly, a display device provides for the presentation of GUIs, application software data, and multimedia presentations, for example. In the embodiment of FIG. 10, the I/O devices and interfaces 1012 also provide a communications interface to various external devices. The computing system 1000 may also comprise one or more multimedia devices 1006, such as speakers, video cards, graphics accelerators, and microphones, for example.

Computing System Device/Operating System

The computing system 1000 may run on a variety of computing devices, such as, for example, a mobile device or a server, a Windows server, an Structure Query Language server, a Unix server, a personal computer, a mainframe computer, a laptop computer, a cell phone, a personal digital assistant, a kiosk, an audio player, a smartphone, a tablet computing device, and so forth. The computing system 1000 is generally controlled and coordinated by operating system software, such as iOS, z/OS, Windows 95, Windows 98, Windows NT, Windows 2000, Windows XP, Windows Vista, Windows 7, Linux, BSD, SunOS, Solaris, or other compatible operating systems. In Macintosh systems, the operating system may be any available operating system, such as MAC OS X. In other embodiments, the computing system 1000 may be controlled by a proprietary operating system. Conventional operating systems control and schedule computer processes for execution, perform memory management, provide file system, networking, and I/O services, and provide a user interface, such as a graphical user interface (“GUI”), among other things.

Network

In the embodiment of FIG. 10, the computing system 1000 is coupled to a network 1018, such as a LAN, WAN, or the Internet, for example, via a wired, wireless, or combination of wired and wireless, communication link 1016. The network 1018 communicates with various computing devices and/or other electronic devices via wired or wireless communication links. In the embodiment of FIG. 10, the network 1018 is communicating with one or more computing systems 1020 and/or one or more data sources 1022.

Access to the dynamic electronic border control system module 1014 of the computer system 1000 by computing systems 1020 and/or by data sources 1022 may be through a web-enabled user access point such as the computing systems' 1020 or data source's 1022 personal computer, cellular phone, laptop, or other device capable of connecting to the network 1018. Such a device may have a browser module is implemented as a module that uses text, graphics, audio, video, and other media to present data and to allow interaction with data via the network 1018.

The browser module may be implemented as a combination of an all points addressable display such as a cathode-ray tube (CRT), a liquid crystal display (LCD), a plasma display, touch screen display or other types and/or combinations of displays. In addition, the browser module may be implemented to communicate with input devices 1012 and may also comprise software with the appropriate interfaces which allow a user to access data through the use of stylized screen elements such as, for example, menus, windows, dialog boxes, toolbars, and controls (for example, radio buttons, check boxes, sliding scales, and so forth). Furthermore, the browser module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition a touch screen may act as a hybrid input/output device. In another embodiment, a user may interact with the system more directly such as through a system terminal connected to the score generator without communications over the Internet, a WAN, or LAN, or similar network.

In some embodiments, the system 1000 may comprise a physical or logical connection established between a remote microprocessor and a mainframe host computer for the express purpose of uploading, downloading, or viewing interactive data and databases on-line in real time. The remote microprocessor may be operated by an entity operating the computer system 1000, including the client server systems or the main server system, an/or may be operated by one or more of the data sources 1022 and/or one or more of the computing systems. In some embodiments, terminal emulation software may be used on the microprocessor for participating in the micro-mainframe link.

In some embodiments, computing systems 1020 that are internal to an entity operating the computer system 1000 may access the dynamic electronic border control system module 1014 internally as an application or process run by the CPU 1004.

User Access Point

In an embodiment, the computing system 1000 comprises an iPhone®, an iPad®, a smartphone, a tablet computing device, a mobile device, a personal computer, a laptop computer, a cellular phone, a GPS system, a Blackberry® device, a portable computing device, a server, a computer workstation, a local area network of individual computers, an interactive kiosk, a personal digital assistant, an interactive wireless communications device, a handheld computer, an embedded computing device, or the like.

Other Systems

In addition to the systems that are illustrated in FIG. 10, the network 1018 may communicate with other data sources or other computing devices. The computing system 1000 may also comprise one or more internal and/or external data sources. In some embodiments, one or more of the data repositories and the data sources may be implemented using a relational database, such as DB2, Sybase, Oracle, CodeBase and Microsoft® SQL Server as well as other types of databases such as, for example, a signal database, object-oriented database, and/or a record-based database.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present invention herein disclosed should not be limited by the particular disclosed embodiments described above.

What is claimed is:

1. A computer-implemented method for controlling a dynamic border of a mobile computing device, the computer-method being implemented by a physical processor of the mobile computing device, the computer-implemented method comprising:
receiving, by the physical processor, a sensor signal indicating detection of a user contact or a user input for triggering deactivation of an edge portion of a display screen of the mobile computing device; and
deactivating, by the physical processor, the edge portion of the display screen in response to the user contact or user input.

2. The method of claim 1, wherein deactivating the edge portion of the display screen comprises displaying a colored border on the display screen, wherein the colored border corresponds to the deactivated edge portion of the display screen.

3. The method of claim 1, wherein deactivating the edge portion of the display screen comprises deactivating a series of display pixels along an edge of the display screen.

4. The method of claim 1, wherein deactivating the series of display pixels comprises shutting off the series of display pixels.

5. The method of claim 1, further comprising receiving, by the physical processor, a user contact duration signal indicating a duration of the user contact, wherein deactivating the edge portion of the display screen comprises deactivating the edge portion in response to a user contact that is longer than a threshold duration of time.

6. The method of claim 1, further comprising selecting a border profile by the physical processor, wherein the border profile defines at least one of a dimension of the deactivated edge portion of the display screen and a location on the display screen of the deactivated edge portion.

7. The method of claim 6, wherein selecting the border profile comprises selecting a width of the deactivated edge portion based on a detected width of the user contact.

8. The method of claim 7, further comprising selecting a different border based on a change in the detected width of the user contact.

9. The method of claim 1, wherein the sensor signal indicates detection of a user contact on a backside of the mobile computing device.

10. The method of claim 1, wherein the user input comprises an input to select a border profile for deactivating the edge portion of the display screen.

11. A system for controlling a dynamic border of a mobile computing device, the system comprising:
a non-transitory computer-readable medium having instructions encoded thereon that, in response to execution by a physical processor of the system, causes the physical processor of the system to:
receive a sensor signal indicating detection of a user contact or a user input for triggering deactivation of an edge portion of a display screen of the mobile computing device; and
deactivate the edge portion of the display screen in response to the user contact or user input.

12. The system of claim 11, wherein the mobile computing device further comprise an accelerometer and wherein the physical processor is further configured to receive an angle sensor signal from the accelerometer.

13. The system of claim 12, wherein the physical processor is configured to activate a deactivated edge portion of the display screen if the angle sensor signal indicates that the mobile computing device is in a substantially horizontal position.

14. The system of claim 11, wherein the physical processor is further configured to receive a signal indicating the mobile computing device is docked onto a docking station, wherein the physical processor is configured to activate a deactivated edge portion of the display screen in response to the signal.

15. The system of claim 11, wherein the physical processor is configured to ignore user input in the deactivated edge portion of the display screen.

16. The system of claim 11, wherein the physical processor is configured to display a border on the display screen, wherein the border corresponds to the deactivated edge portion of the display screen.

17. The system of claim 11, further comprising a front side detector for detecting a user contact width.

18. The system of claim 17, wherein the physical processor is configured to select a border profile for the deactivated edge portion of the display screen based on the user contact width, wherein the border profile defines a width of the deactivated edge portion.

19. The system of claim 11, further comprising a front side detector for detecting a duration of a substantially stationary user contact.

20. The system of claim 19, wherein the physical processor is configured to deactivate the edge portion in response to a user contact that is substantially stationary for a duration longer than a threshold period of time.
